(19) United States
(12) Patent Application Publication
(10) Pub. No.: US 2007/0198997 A1
(43) Pub. Date: Aug. 23, 2007

(54) Customer framework for embedded applications

(75) Inventors: Davy Jacops, Kontich (BE); Erik Quanten, Peer (BE)

Correspondence Address: STMicroelectronics Inc.;c/o WOLF, GREENFIELD & SACKS, P.C., 600 Atlantic Avenue, BOSTON, MA, 02210-2206, US

(73) Assignee: STMICROELECTRONICS BELGIUM N.V., ZAVENTEM (BE)

(21) Appl. No.: 10/561,082

(22) PCT Filed: Jun. 17, 2004
(86) PCT No.: PCT/BE04/00088

§ 371 Date: Jan. 29, 2007

(30) Foreign Application Priority Data
Jun. 17, 2003 (EP) 03447155.7

(51) Int. Cl. G06F 9/46

(52) U.S. Cl. 719/328

(57) ABSTRACT

The present invention provides a framework so that software can be embedded into a telecommunications semiconductor device such as an integrated circuit or into a chip. The framework is an API. The telecommunications device may support a telecommunications protocol, e.g. a wireless protocol such as BT. For example the BT Layers above an HCI can support different profiles and/or Applications. The semiconductor devices according to the present invention are particularly suitable for products where no host processor is available to provide the process engine to run the applications software. The semiconductor devices according to the present invention can include an ASIC, an integrated circuit, a multicarrier module (MCM) a printed circuit board or similar. Such devices may find advantageous use in small apparatus, e.g. wireless linked headphones.

### BACKGROUND OF THE INVENTION

1. Field of the Invention

The present invention relates to wireless telecommunication systems, apparatus and methods, especially for short range. The present invention is particularly related to embedded telecommunications apparatus and methods, e.g. for short range wireless communication.

2. Discussion of the Related Art

Bluetooth is a short range wireless telecommunications protocol useful for communication between handheld devices. Further details can be found in “Discovering Bluetooth” by M. Miller, Sybex, 2001 and “Bluetooth, connect without cables”, By J. Bray and C. F. Sturman, Prentice-Hall, 2001.

FIG. 1 shows a schematic diagram of a Host Controller Interface (HCI) from the Bluetooth SIG, HCI Specs, FIG. 1.2, p 544 as applied to a wireless communication between two hosts, Host 1 and Host 2. The HCI is functionally broken up into 3 separate parts:

HCI Firmware is located on the Host Controller, (e.g. the actual Bluetooth hardware device). The HCI firmware implements the HCI Commands for the Bluetooth hardware by accessing baseband commands, link manager commands, hardware status registers, control registers, and event registers. The term Host Controller means the HCI-enabled Bluetooth device.

HCI Driver which is located on the Host (e.g. software entity). The Host will receive asynchronous notifications of HCI events. HCI events are used for notifying the Host when something occurs. When the Host discovers that an event has occurred it will then parse the received event packet to determine which event occurred. The term Host means the HCI-enabled Software Unit.

The HCI Driver and Firmware communicate via the Host Controller Transport Layer, i.e. a definition of the several layers that may exist between the HCI driver on the host system and the HCI firmware in the Bluetooth hardware. These intermediate layers, the Host Controller Transport Layer, should provide the ability to transfer data without intimate knowledge of the data being transferred. Several different Host Controller Layers can be used, of which 3 have been defined initially for Bluetooth: USB, UART and RS232. The Host should receive asynchronous notifications of HCI events independent of which Host Controller Transport Layer is used.

The HCI provides a uniform command method of accessing the Bluetooth hardware capabilities. The HCI Link commands provide the Host with the ability to control the link layer connections to other Bluetooth devices. These commands typically involve the Link Manager (LM) to exchange LMP commands with remote Bluetooth devices.

The HCI Policy commands are used to affect the behavior of the local and remote LM. These Policy commands provide the Host with methods of influencing how the LM manages the piconet. The Host Controller and Baseband commands, Informational commands, and Status commands provide the Host access to various registers in the Host Controller.

The Host Controller Transport Layer provides transparent exchange of HCI-specific information. These transporting mechanisms provide the ability for the Host to send HCI commands, ACL data, and SCO data to the Host Controller. These transport mechanisms also provide the ability for the Host to receive HCI events, ACL data, and SCO data from the Host Controller. Since the Host Controller Transport Layer provides transparent exchange of HCI-specific information, the HCI specification specifies the format of the commands, events, and data exchange between the Host and the Host Controller.

The Link Control commands allow the Host Controller to control connections to other Bluetooth devices. When the Link Control commands are used, the Link Manager (LM) controls how the Bluetooth piconets and scatternets are established and maintained. These commands instruct the LM to create and modify Link layer connections with Bluetooth remote devices, perform Inquiries of other Bluetooth devices in range, and other LMP commands.

The Link Policy Commands provide methods for the Host to affect how the Link Manager manages the piconet. When Link Policy Commands are used, the LM still controls how Bluetooth piconets and scatternets are established and maintained, depending on adjustable policy parameters. These policy commands modify the Link Manager behavior that can result in changes to the Link layer connections with Bluetooth remote devices.

The Host Controller & Baseband Commands provide access and control to various capabilities of the Bluetooth hardware. These parameters provide control of Bluetooth devices and of the capabilities of the Host Controller, Link Manager, and Baseband. The host device can use these commands to modify the behavior of the local device.

The Informational Parameters are fixed by the manufacturer of the Bluetooth hardware. These parameters provide information about the Bluetooth device and the capabilities of the Host Controller, Link Manager, and Baseband. The host device cannot modify any of these parameters.

The Host Controller modifies all status parameters. These parameters provide information about the current state of the Host Controller, Link Manager, and Baseband. The host device cannot modify any of these parameters other than to reset certain specific parameters.

The Testing commands are used to provide the ability to test various functionality of the Bluetooth hardware. These commands provide the ability to arrange various conditions for testing.

The objective of the HCI UART Transport Layer is to make it possible to use the Bluetooth HCI over a serial interface between two UARTs on the same PCB. The HCI UART Transport Layer assumes that the UART communication is free from line errors. Event and data packets flow through this layer, but the layer does not decode them.

The objective of the HCI RS232 Transport Layer is to make it possible to use the Bluetooth HCI over one physical RS232 interface between the Bluetooth Host and the Bluetooth Host Controller. Event and data packets flow through this layer, but the layer does not decode them.

The objective of the Universal Serial Bus (USB) Transport Layer is to the use a USB hardware interface for Bluetooth hardware (which can be embodied in one of two ways: as a USB dongle, or integrated onto the motherboard of a notebook PC). A class code will be used that is specific to all USB Bluetooth devices. This will allow the proper driver stack to load, regardless of which vendor built the device. It also allows HCI commands to be differentiated from USB commands across the control endpoint.

The above HCI scheme provides a bit-level interface which is dedicated to one transmission task. It is however, not very flexible and does not allow easy customization for different applications.

### SUMMARY OF THE PRESENT INVENTION

It is an object of the present invention to provide a framework so that software can be embedded more flexibly into a telecommunications device.

The present invention provides a library of software program products, the library comprising a set of routines for an embedded software application requiring SW protocol layers, profiles and/or application code embedded on a processor, the library providing an interface between the software application running on the processor and the SW protocol layers and/or the profiles and/or the application code.

The interface can be between the software application running on the processor and a telecommunications module, for example the Bluetooth lower layer SW protocol.

The interface may use a telecommunications controller interface communication such as the HCI communication for communication with the telecommunications module.

The software application can communicate with the telecommunications module for executing a telecommunications protocol. The software application can also communicate with a hardware input/output interface. The library can be stored on a computer readable medium, such as a CD-ROM or DVD-ROM or a memory or data storage device. The present invention also includes a host processing system for executing the library of computer programs.

The present invention also provides a telecommunications device with an interface towards an underlying operating system, to layers of a telecommunications protocol and optionally towards any hardware available for an embedded application, wherein the interface communicates with the telecommunications protocol via a telecommunications hardware controller interface such one using HCI communications. The interface can be an API.

The present invention also includes an API for providing functions to a software application requiring SW protocol layers, profiles and/or application code embedded on a processor, the API communicating with the protocol layers using telecommunications controller interface communications such as HCI communications. The present invention also includes an API for providing functions to a software application requiring SW protocol layers, profiles and/or application code embedded on a processor, the API communicating with an operating system of a microprocessor and providing operating system functions to the software application.

The present invention also includes an API for providing functions to a software application requiring SW protocol layers, profiles and/or application code embedded on a processor, the API communicating with hardware input/output devices for providing I/O services to the software application. Any of the API's can be stored on a computer readable medium.

The present invention also provides a method of embedding a software application requiring SW protocol layers, profiles and/or application code embedded on a processor, the method comprising: generating an API for communicating with the protocol layers via telecommunications controller interface communications. The present invention also provides a method of embedding a software application requiring SW protocol layers, profiles and/or application code embedded on a processor, the method comprising: generating an API for communicating with hardware input/output devices to provide I/O services for the software application. The present invention also provides a method of embedding a software application requiring SW protocol layers, profiles and/or application code embedded on a processor, the method comprising: generating an API for communicating with an operating system of a microprocessor and providing operating system functions to the software application.

The present invention also provides a method of operating a telecommunications device with an interface towards an underlying operating system, to layers of a telecommunications protocol and optionally towards any hardware available for an embedded application, the interface operating with the telecommunications protocol via a telecommunications controller interface communications such as HCI communications.

The present invention will now be described with reference to the following drawings.

### BRIEF DESCRIPTION OF THE DRAWINGS

FIG. 1 shows a conventional HCI interface.

FIGS. 2a and 2b show schematic architectures in accordance with embodiments of the present invention.

FIG. 3 shows a schematic an API in accordance with embodiments of the present invention.

FIG. 4 shows schematically how an RTOS abstraction layer interfaces with the RTOS in accordance with an embodiment of the present invention.

FIG. 5 shows a preemptive scheduling scheme in accordance with an embodiment of the present invention. Interrupt handler is not shown, only task activity.

FIG. 6 shows a nested priority based interrupt scheduling scheme in accordance with an embodiment of the present invention.

FIG. 7 shows a flow diagram for an application build for use with the present invention.

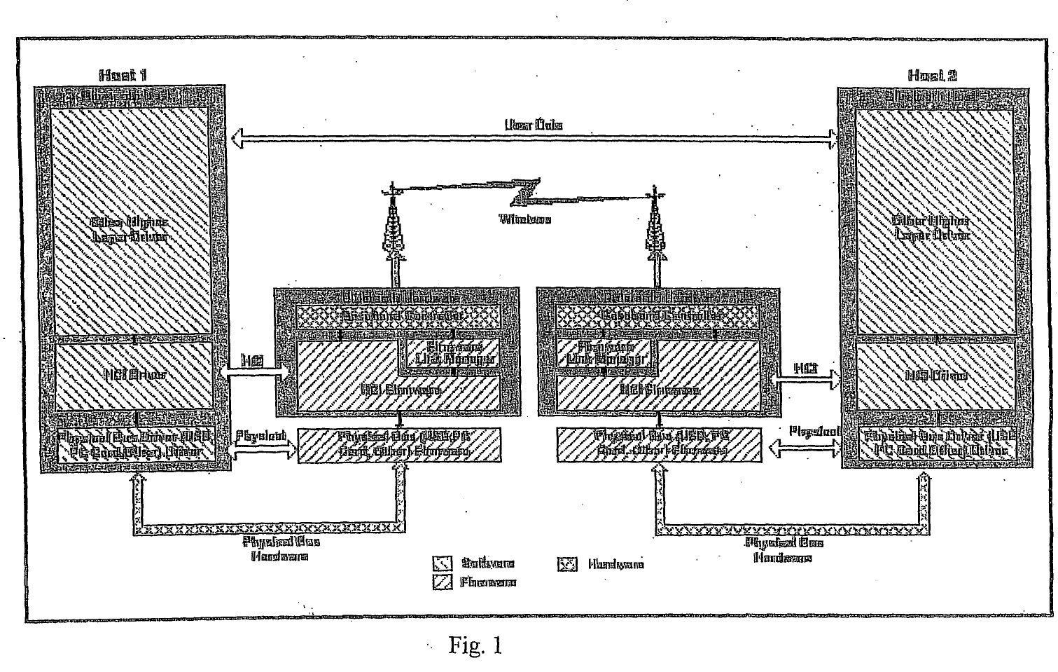

Definitions, Acronyms and Abbreviations

API Application Programming Interface

BB BaseBand

BT Bluetooth

GPIO General Purpose Input/Output

HCI Host Controller Interface

IRQ Interrupt Request

ISP Interrupt Service Procedure

LC Link Controller

LMP Link Manager Protocol

NMI Non Maskable Interrupt

RAM Random-Access Memory

ROM Read-Only Memory

RTOS Real Time Operating System

SDL Specification and Description Language

SIG (BT) Special Interest Group

SPI Serial Peripheral Interface

SW Software

TCB Task Control Block

UART Universal Asynchronous Receiver-Transmitter

### DETAILED DESCRIPTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. Where the term “comprising” is used in the present description and claims, it does not exclude other elements or steps. Where an indefinite or definite article is used when referring to a singular noun e.g. “a” or “an” “the”, this includes a plural of that noun unless something else is specifically stated.

The present invention provides a framework so that software can be embedded into a telecommunications semiconductor device such as an integrated circuit or into a chip. The telecommunications device may support a telecommunications protocol, e.g. a wireless protocol such as BT. For example the BT Layers above an HCI can support different profiles and/or Applications. The semiconductor devices according to the present invention are particularly suitable for products where no host processor is available to provide the process engine to run the applications software. The semiconductor devices according to the present invention can include an ASIC, an integrated circuit, a multicarrier module (MCM) a printed circuit board or similar.

Such devices may find advantageous use in small apparatus, e.g. wireless linked headphones.

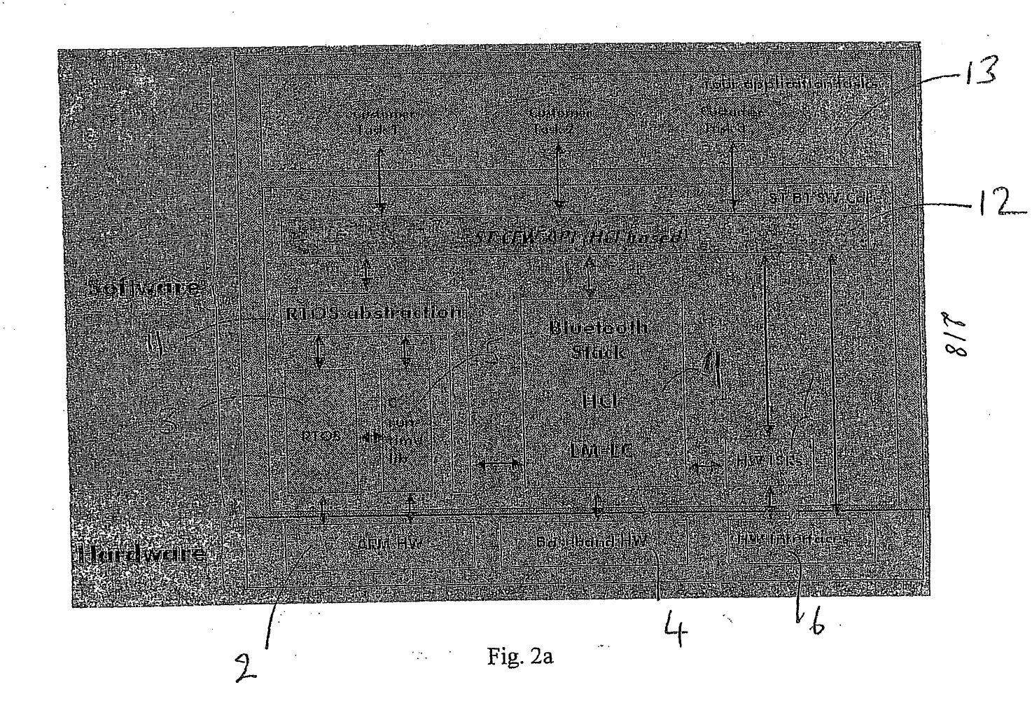

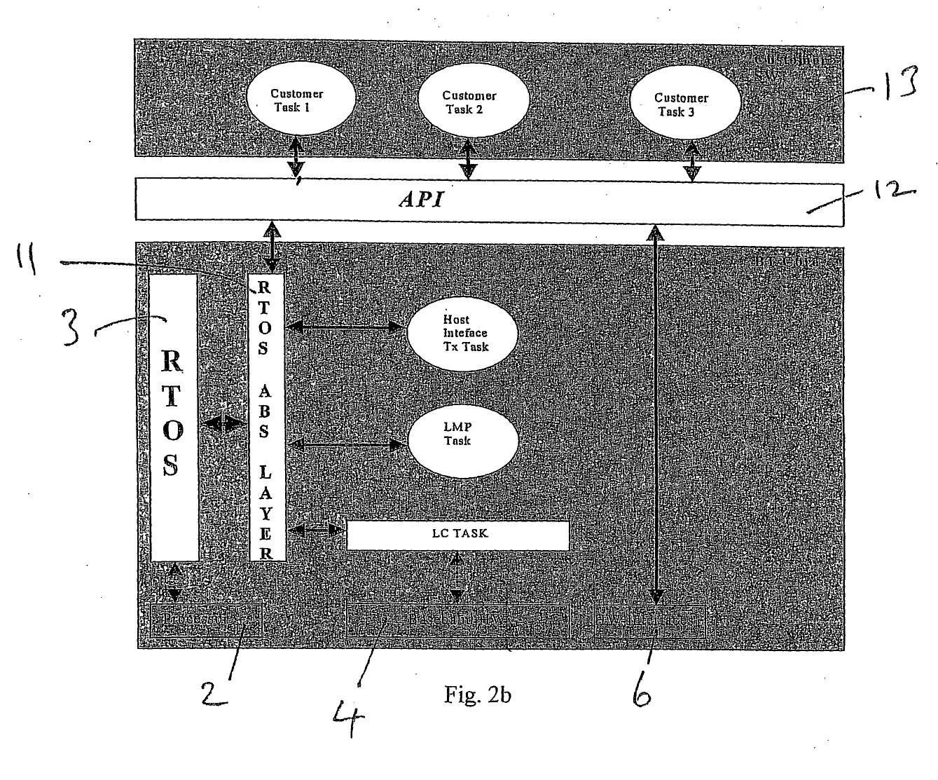

FIG. 2a shows a schematic block diagram of an embedded architecture according to an embodiment of the present invention. It comprises hardware such as a microprocessor with associated memory and registers, an optional telecommunications protocol processing block, e.g. a digital signal processing block whose duty is to implement specific lower layer telecommunication protocols, and hardware interfaces 6. Alternatively, the telecommunications protocol processing block may be comprised by the microprocessor running appropriate software. The hardware interfaces 6 may be associated with interrupt service registers 7. Software running on these hardware devices comprises a Real Time Operating System 3 running on the microprocessor 2 as well as an RTOS library 5 of routines for use by the RTOS. Application software 9 for the lower layer telecommunication protocols, e.g. the BT stack, is provided for the baseband hardware 4 and this can at least partly run on the microprocessor 2. The RTOS can communicate with the software for the lower layer protocols 9, e.g. via an RTOS abstraction layer 11.

The present invention provides a means of seamlessly hooking up a customer specific embedded applications or tasks 13 (Application layer, Profiles, BT upper layers (RFCOMM, SDP, L2CAP, . . . ) with the available BT lower stack 9. The interface between upper and lower stack is located at the HCI level. The interface is provided in the form of an API 12. The main requirement of the API 12 is to provide the customers with a Customer Framework (CFW) in which they can be capable of autonomously develop and integrate their Bluetooth Host Protocol layers and Applications 13 using the system resources of the chip. System resources can be any of the following as provided on or off the chip:

Volatile or non-volatile memory, e.g. ROM/Flash where the customers' application code is stored

RAM used by the customer's data structures

Processing power from a microprocessor 2

The API 12 is a very thin set of routines that can be used by the customer SW's to access the RTOS system resources, the services related to a telecommunications protocol, e.g. as provided by the Bluetooth stack and access to some HW interfaces (GPIO pins for example). The interface is message based. The API 12 has an identifier, formal parameters and an observable behavior. It allows procedure calls.

FIG. 2b shows a simplified version of FIG. 2a giving the basic architecture of the customer's software, e.g. tasks 1 to 3, the BT core provided on a single processor 2 and comprising a RTOS 3 and an RTOS abstraction layer 11, the API 12 and the hardware interfaces 6. All functions performed by the RTOS 3 (task communication, timers, semaphores, etc.) are accessible by the customer applications 13 via the Customer Framework (CFW), i.e. via the API 12, so there is no need for directly calling RTOS functions. Also the access to hardware resources 6 (e.g. GPIO, UART) is done via the CFW, i.e. the API 12. The HW 6 never needs to be addressed directly by the customer application 13.

An embodiment of the present invention comprises the following building blocks:

1. BT Baseband controller core

2. On chip memory, e.g. RAM

3. On chip memory, e.g. Flash/Boot Rom

4. Hardware (HW) Interfaces (e.g. UART, GPIO, SPI, USB)

5. An optional customer specific hardware module which communicates with the HW interfaces

6. BT software (SW) implementing the host controller layers as defined by BT SIG (e.g. HCI layer, LC and LMP)

7. an RTOS for a processor core, e.g. an RTOS for Thumb (ARM)

8. On chip microprocessor core, e.g. ARM7TDMI

To allow development of software for the microprocessor including compiler a suitable toolkit is required, e.g. the ARM Software Development Toolkit (compiler, linker, librarian, etc. . . . ). For further details of ARM processor cores, see “ARM system-on-chip architecture”, S. Furber, Pearson Education, 2000, especially the section on chapters 7 and 13.

The chip has on-chip random access memory (RAM) and may have further external RAM as well as non-volatile or volatile off-chip memory such as FLASH memory. The BT lower protocol stack SW can run on the embedded processor core.

Depending on the desired configuration and feature-set, an amount of RAM and FLASH currently remains unused. This allows embedding applications on top of the BT lower protocol stack. For this purpose, the Customer Framework API 12 is provided. This API 12 provides all the necessary interfaces towards the underlying RTOS 3, the HW interfaces 6 (e.g. GPIO, UART, USB, I2C, SSI, . . . ), and the BT lower stack 9 itself. The API 12 between the customer applications 13 and the BT lower stack 9 is preferably conformant to the HCI specification.

1. The API 12

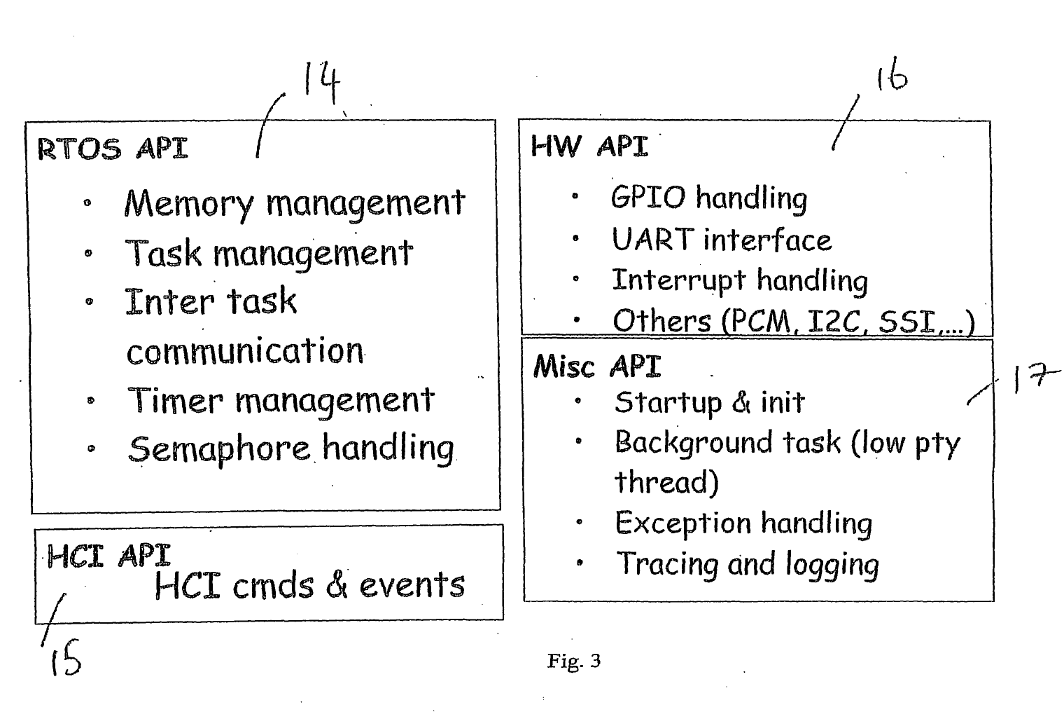

API 12 (FIG. 3) is constructed by considering the technical functions which need to be provided for the associated software components which will access it. The API provides full control of these functions. API 12 provides functions to a software application requiring SW protocol layers, profiles and/or application code embedded on a processor. The API communicates with the protocol layers using telecommunications controller interface communications, e.g. HCI communications.

The API 12 may comprise at least 3 types of API for controlling different functions: An RTOS API 14 which provides memory management, task management, inter-task communication, timer management and semaphore handling.

A telecommunications controller interface API 15, e.g. an HCI API which provides commands conformant with the controller interface and handles events, e.g. HCI conformant commands and handles HCI events.

A Hardware (HW) interfaces API 16 which provides handling of the 10 devices, such as GPIO, UART handling as well as interrupt handling.

In addition a miscellaneous API 17 for general tasks is provided which provides startup and initialization, background tasks, e.g. a low priority thread, exception handling and tracing and logging.

The four API's 14-17 may be integrated as a single API or as four, three or less separate API's.

1.1 HCIAPI

The BT Host Controller Stack (Lower Layers Stack) includes all baseband functionality and SW layers up to the lower HCI layer. This HCI layer is a standardized interface and is the interface for defining the API 12 associated to Bluetooth functionality. However, since the customer Host Protocol stack/Application is going to be embedded and running in the same processor as the Host Controller Stack, the HCI Layer and HCI Transport Layer can be considered as virtually empty.

As a result, the HCI API which is part of API 12 to be used for communication with the customer application is based on the format of the HCI commands and events.

From a physical point of view the transport mechanism is implemented by means of RTOS message passing and/or direct function calls when the customer's tasks or other tasks want to send HCI Commands, HCI Data and HCI Events between each other. For example, a customer L2CAP task would prepare a buffer containing a standardized HCI command (as they would in a two-processor solution) and call a routine send HCI command (buffer*) which would send the command to the LMP. If the Host Interface Transmission Task wants to send an HCI Event, it could do so by sending a message to the L2CAP task or by providing a callback routine defined by the customer. For some specific HCI commands the customer would need to know the format of those commands and use the same mechanism as the standard HCI commands.

1.2 HWInterfacesAPI

The API 12 also provides the means for the customer application to read/write in any of the hardware interfaces such as GPIO pins that are free for customer use. For example, the API should provide the means for the customer to configure the free GPIO pins as input, output or interrupt.

The customer application might need to have access to an interrupt device (for example a button in a headset) by using one of the GPIO pins. This could be done in two ways, for example:

The API defines a routine to read the status of the GPIO pins and the customer polls the status using this routine.

An interrupt is triggered whenever the status of the any of the customer GPIO pins changes. A customer task can register by means of an API routine to receive a message indicating that there was a change in one of the GPIO pins, and the message is sent by a defined ISR indicating the current status of the pins.

2. The Structure and Interfaces of the Lower Layers of the Baseband Software Protocol Stack

2.1 Link Controller

The LC provides the intelligence for driving the baseband hardware and deals with packet level and slot level control. The LC functionality can be split in three major parts: Programming the baseband registers with the required link information to allow it to transmit or receive in the next slot or packet Allocating future slots between different connections and states Receiving data from the baseband and sending it to the higher layers The programming of the baseband registers has to be done as rapidly as possible to allow the radio to be programmed in time to transmit or receive in the next slot.

2.2 Link Manager Protocol

The link manager manages the device and connections in the long term. Its primary tasks are: Instructing the link controller to move between states Implementing the LMP protocol Implementing the HCI specification The HCI transport is a self-contained separate task in order to keep the transport details transparent to the LM.

3. RTOS

Embodiments of the present invention provide services via the CFW which can be mapped into a RTOS ABSTRACTION LAYER and/or an operating system (OS).

The way these services are mapped much depends on a balance between portability and functionality. In one preferred embodiment the CFW is mapped into the RTOS ABSTRACTION LAYER instead of doing it directly into the RTOS, since a change in the RTOS would be transparent to the CFW. It is not necessary for the RTOS ABSTRACTION LAYER to provide all the possibilities available from the RTOS. Hence, the present invention includes defining some services offered by the CFW in terms of OS services, and some being defined as an extension to the RTOS ABSTRACTION LAYER.

The API provides a subset of the possibilities offered by the OS services in order to avoid the customer abusing the system. None of the OS files should be visible to the customer. The API is preferably based as much as possible in the RTOS ABSTRACTION LAYER.

Some maximum configuration parameters (for example maximum number of tasks to be created by the customer) can be defined in a special customer configuration file. This file is not visible or modifiable by the customer, but contains configuration parameters relevant for the API and used at compilation time before delivery of the CFW library to the customer.

The API includes calls to retrieve the maximum values configured for RTOS resources used by the customer application. It is responsibility of the customer to bind to these although the API will control that the customer application is not trying to cross the set limits, for example a customer application trying to create more tasks than allowed.

The API 12 is preferably based not on macros but on routine calls in order to hide implementation and details of calls to the OS.

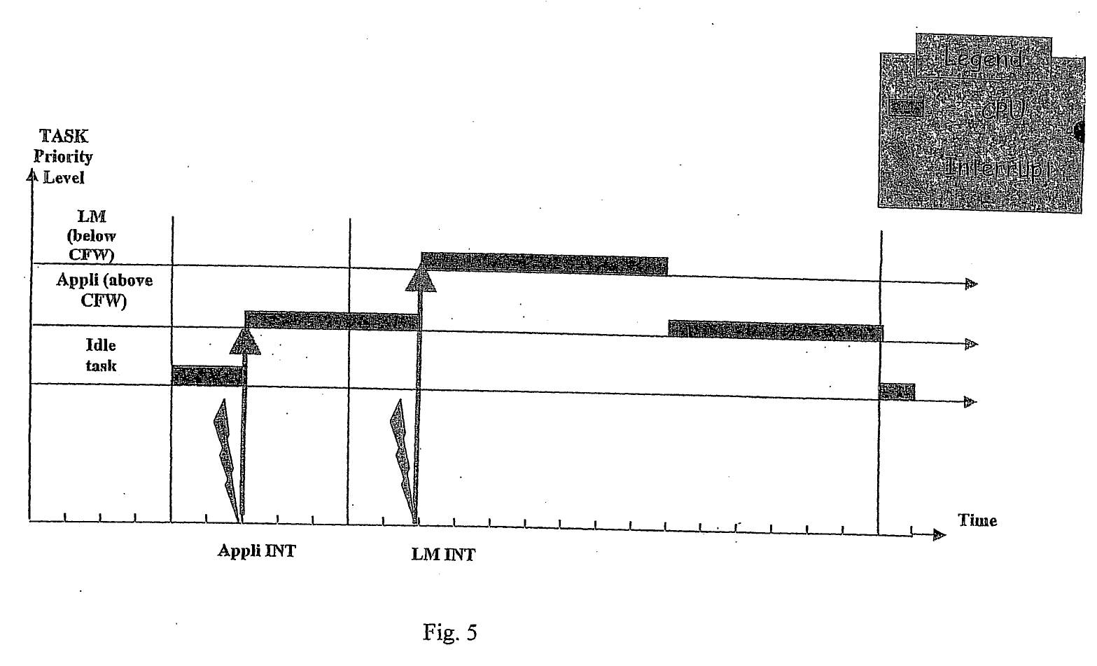

The RTOS is preferably a real-time multitasking system that allows the concurrent execution of different application program modules (tasks) on a single processor in an orderly manner. Preferably, a preemptive priority-driven scheduling algorithm is used (FIG. 5), which ensures that the highest priority task that is ready to do useful work will always have control of the processor. This pre-emptive mechanism can coexist with a time-slicing one as explained later on. The services of the operating system may be those provided by standard RTOS and may include, amongst others, buffer allocation, memory management, inter-task communication and synchronization, interrupt handling, timer management, etc. . . .

The following are preferable capabilities that are offered by the RTOS and that determine what type of services the API can provide in the development framework.

3.1. Startup and Shut Down

The operating system can be started up and shut down by the respective calls.

The initialization and shutdown of the API itself can be done as part of an OS Restart and an optional OS Exit procedure. The initialization is needed but the shutdown is not essential. Restart procedures can be procedures to be called during OS startup. It does not mean they are called during an OS restart. Within that initialization the API will provide an empty routine to be defined by the customer for customer specific general initialization. This initialization is done after OS has been initialized. It is used in case the customer needs to do initialization common to all tasks. Furthermore, the API will guarantee that for every task that is being started dynamically, an associated initialization routine (as defined by the customer) will be called once before the task enters the main message waiting/handling loop.

With the call to start up, a kernel is initialized, it enables the interrupts and executes the sequence of application Restart Procedures provided in the Restart Procedure List of the System Configuration Module. User provided Restart procedures could invoke relevant services to start tasks and initialize interval timers

When the operating system (OS) shutdown is called, the operating system executes the sequence of application Exit Procedures (to restore original environment prior to the launch of the OS) provided in the Exit Procedure List of the System Configuration Module, and then it returns to the point where OS was launched.

Shutdown is optional. Alternatively, once the system is started up it can run until reset or power down.

3.2. Task Management

3.2.1 Task Creation

For the creation of tasks there are different possibilities offered by the OS services:

The customer can define the tasks dynamically during runtime. This is the most flexible scheme for the customer in case the customer's protocol stack configuration in terms of number of tasks is not known at compilation time. It has the advantage that the CFW library does not need to be recompiled, but extra code needs to be added to the framework to provide protection to runtime errors caused by the customer's application not respecting the indicated system limits. The API can use the memory management services provided by OS in order to manage the structures necessary for the definition of each task.

Alternatively, the customer can define the tasks statically in the configuration file, but this configuration is somehow hooked up into the OS System Configuration module and then the customer's tasks would start up as part of the OS startup sequence. This solution is simpler and less prone to runtime errors, but then the CFW library would need to be recompiled and it would mean that sources would need to be released to the customer.

Hence, in embodiments of the present invention tasks can be created in a static way via the Configuration Module processed at Startup or dynamically from Restart Procedures or other Tasks by means of the corresponding service calls. The maximum number of tasks in the system is preferably User Defined and it sets an upper limit to the number of tasks that can be created by the application. When creating a task dynamically the application provides, amongst others, a 4-character tag that will be associated with the task, a pointer to the task entry point code and the time slice associated with the task if supported. Another important parameter in the definition of the task is the pointer to a statically allocated (reserved at compilation time) RAM region to be used by the OS as storage for the tasks Stacks and Task Control Block.

The OS returns to the application a Task Id that can be used to reference that task in other OS service calls.

3.2.2 Task Deletion

Even though the customer application might create tasks dynamically, it might be possible that it will never need the explicit deletion of tasks. In most cases the dynamic creation is just used because protocol stacks need to configure and register different layers when the whole stack is started up but this configuration remains the same during the “rest of the protocol stack life”. However, in case the customer application needs this service or memory usage of the system should be improved, this service could be used for deletion of the associated unnecessary resources.

Hence, in embodiments of the present invention, tasks can be dynamically deleted or killed by using the extended task termination procedures provided by the OS. It allows the de-allocation of resources used for the management of the task by the OS (stack and TCB for example) and the call of the task's Task Termination Procedure. Tasks can kill themselves. The main parameter for the deletion of the task is the Task Id.

3.2.3 Task Ending

Forcing the ending of the task and returning control to the RTOS scheduler is useful in some situations, for example to exit easily from very deep nested execution.

However, if the customer application has in place correct design and coding procedures this situation should not arise since it is not a good programming practice anyway. Therefore, it is not essential to support this service in the API.

Hence, a task normally ends when its task procedure returns to the OS.

However, under some circumstances a task may wish to end but due to procedure nesting, cannot easily do so. In such cases the task can invoke an OS service to end the task and return control immediately to the OS scheduler

3.2.4 Task Execution

The preemptive nature of the RTOS together with the task prioritization will have a key role in preventing the customer SW from affecting the performance of the lower layers. As in any other protocol stack, the real time constraints of the lower layers are much tighter than the higher layers. Hence, the real time needs of, for example, the LMP layer (not to mention the LC) of the lower stack, are more stringent than that of other layers above HCI.

It can be stated that the LC activities should not be affected by the addition of customer's defined tasks.

The rest of the LC executes with the highest priority IRQ associated with RTOS. Preferably, all user's tasks are executed with interrupts enabled and therefore the ISPs would always preempt the execution of such tasks. The customer application should not be able to disable the interrupts or perform any actions that might affect the normal interrupt and priority handling of the RTOS. For example, the API should not provide any routines to provide to the customer application with such a capability.

For the rest of the SW tasks (LMP, Host Interface Tx), which run as a normal RTOS tasks, interference from customers tasks can be avoided by using task prioritization. If the customers tasks run with a priority lower than the priority assigned to the SW tasks, neither of these SW tasks will ever get preempted by customers tasks ready to be executed. As a matter of fact, the stated requirement on the priority level assigned to the customers task, will guarantee that any task will always preempt any customers task and take control of the processor for as long as it is necessary. Only when other tasks are idle and no interrupts are generated will the customers' task be scheduled by the RTOS. For example, the creation of customers' tasks by means of the API can be defined in such a way that the priorities assigned to the customers' tasks will always be lower than the priorities assigned to our tasks.

Tasks can request from the OS a special privileged mode in which interrupts are enabled but no higher priority tasks can kick in, not even the Kernel Task and the OS preferably offers the possibility for a task to change its own priority or other task's priority on the fly. These special services from OS should not be open to the customer application in the API.

One of the problems that can arise from allowing customer development of applications to run with an API is the possibility for the customer to define a task that never returns control of the processor to the RTOS. This would not affect in any way the processing associated with other tasks, since the preemptiveness of the other tasks other tasks would be scheduled anyway. However, if this customer task had a higher priority than the other customer tasks, the whole customer application would block. In this case buffers allocated by the lower layers and sent to the higher layers for processing might never be de-allocated again and run out of memory would be possible causing some runtime exception. If all the customer tasks run in a time sliced fashion, misbehavior in a customer task would not affect the rest and the problem would be reduced. Time slicing would not affect other tasks since time slicing is done for tasks with the same priority and other tasks run at higher priority. Means to detect the problem can be provided, e.g. as an SW watchdog, if not provided by HW. A HW watchdog can also be provided. A special task can be defined with a lower priority than that of the rest of the customer tasks plus a timer to act as a watchdog. The timer would be restarted every time the watchdog task is scheduled. If the timer expired, the associated Timer Procedure would be triggered. It can be guaranteed that Timer Procedures are scheduled if all the Timer Procedures are executed in the context of the Kernel Task (priority 0). In this Timer Procedure tracing or logging information about the abnormal condition can be provided. It can be used as a breakpoint in debugging environments with emulators or provide a soft/hard reset of the board in production systems.

Accordingly, the present invention provides an API that will allow the customer to define tasks with different priority levels. The API can provide a set of priorities to the customers' task, all being lower than OS tasks.

In embodiments of the present invention, the RTOS starts a task execution at the task's start address specified in the task's definition. Since the OS is a preemptive RTOS, the task execution is suspended if another higher priority task becomes ready for execution (which can happen if the executing task performs an operation that invokes a task of higher priority—see FIG. 5). Once a task is scheduled, it inhibits the performance of lower priority tasks and continues to execute until it decides to relinquish control by calls to the OS (return to the Task Scheduler, wait for event, wait for timed interval, etc. . . . ). For example, a real time application which is below the API 12 level has priority over a task such as LM above the API level (see FIG. 5). As soon as the condition that suspended the task stops, the task is resumed at the point it was suspended.

During the execution of a task the interrupts are enabled. However, they can be disabled for a short period of time or the task can request a special privileged mode in which interrupts are enabled but no higher priority tasks can kick in (not even the Kernel Task).

Application task priorities in a range from 1 (highest) to 127 (lowest) inclusive.

The Kernel Task runs with priority 0. The OS offers the possibility for a task to change its priority or other task's priority at runtime. The OS can support time slicing for tasks having the same priority level. The OS can be configured statically to support time slicing by specifying it in the System Configuration Module, or otherwise it can be dynamically enabled and disabled at runtime. One of the parameters for the definition of a task is the time slice in system ticks assigned to it. This specifies the number of system ticks that the scheduler will give to the task before the task is forced to relinquish the processor to another time slice task (of the same priority). If the time slice is zero the task is not time sliced. After the task creation the time slice associated with a task can be changed dynamically. Once time slicing is enabled, the task is time sliced with other time sliced task of the same priority.

3.2.5 Instantiation

The OS does not need to support instantiation within a task and task instances can be implemented as different tasks in the system. The RTOS ABSTRACTION LAYER can implement macros that expand a multi-instance task into several OS tasks. For example, there can be two approaches for the support of instantiation in customer's tasks:

Use of the RTOS ABSTRACTION LAYER approach with an explicit kernel task definition for each instance. This approach requires the different tasks to have their own identification, Stack space and Queue and therefore the customer code needs to be aware of that for inter-task communication.

Provide only single instance tasks and let the customer implement instantiation. The instantiation is done within the customer task. In this case the task identification, stack space and queue are common for all the instances of the task and the customer needs to provide the means for instance separation (for example including instance number in every signal sent to a multi-instance task). In this case even though the tasks' Stack is common, every instance would need to have their own data space to maintain private data across transitions (dynamic memory allocation could then be used for that).

Hence, in accordance with embodiments of the present invention the RTOS need not support instantiation explicitly as part of its services. Instances can be implemented as separate tasks entities that use the same code stack as long as this code is re-entrant.

Message Exchanges and Mailboxes have an associated id to be tracked by the application and an optional Tag. A Message Exchange can be dynamically deleted (if no task is waiting on it or no messages are being held).

3.2.6 Message Passing

If the customer application needs to support message priorities this can be done by the use of Message Exchanges and if not, Mailboxes can be sufficient. It is recommended for code size reduction to have only one or other in the system but not both. When a customer task wants to send a signal to another task, it needs to know only the Task Id or Task tag of the recipient task. The API can then find out by means of OS system calls what is the associated Message Exchange Id or Mailbox Id associated to the task.

The mode in which the sending task waits for acknowledgment of the reception of the message need not be supported since it does not seem necessary and can raise unnecessary problems when used by the customer application.

The API should allow the customer application to retrieve the maximum number of bytes that can be passed by value in a message envelope. It is the responsibility of the customer SW to allocate a buffer and use it to pass it in the envelope if the size exceeds that maximum.

The API preferably provides routines to let the customer copy bytes into the allocated buffers. In this way the API can provide range and pointer checking.

Accordingly, in the RTOS, according to embodiments of the present invention, there are two different input queue structures that can be associated to a task. One is the Mailbox and the other the Message Exchange. The main difference is that the Message Exchange supports 4 different levels of priorities whereas the Mailbox only supports a single priority level. It is recommended by to use in the system one type or the other, but not the two at the same time in order to minimize the code size of the system (the OS can be configured to leave out certain parts of functionality). When configuring a Mailbox or Message Exchange the maximum number of messages they can hold (depth) has no effect on memory requirements. Message Exchanges and Mailboxes have an associated identifier to be tracked by the application and an optional 4-character tag. A Message Exchange can be dynamically deleted.

In the RTOS any task can send a message to another task as long as it knows the recipient task's Message Exchange Id or Mailbox Id. These Ids can be derived from the Task Id by means of system calls.

The basic structure used to manage the message passing between tasks is the envelope. The OS maintains a list of free envelopes. When a task wants to send a message to another task, it needs to specify the destination mailbox, priority (0 to 3) and if the sender needs to wait for acknowledgment of reception. A free envelope is allocated by the OS and all message parameters are copied by value (including array) into the envelope.

The maximum number of parameter bytes that can be sent in a message is defined in the System Configuration Module. It is preferred to know what is the absolute maximum message size that can be sent in the system (by value in the envelope it is). This maximum needs to be known and if the a bigger message needs to be sent, the CFW library can be re-complied again or else buffer allocation is necessary as well as passing the buffer pointer.

3.2.7 Message Exchange Tasks

Message Exchange Tasks allow the runtime creation of tasks and their associated private message exchanges. It is done by means of a system call that ties the task and message exchange up together.

3.2.8 Buffer Management

After considering the amount of RAM memory that is left for customer's purposes, chunk of memory which is going to be used for the different customer's needs can be defined statically. One of these needs is the definition of buffer pools of different sizes for the messages exchanged between the different customer's tasks.

Common buffer pools for the BT Lower Layers and the customer's Higher Layers can be used. However it seems much better for proper dimensioning to have different sets of buffer pools for BT Lower Layers and customer's Higher Layers. The total amount of memory available for customer buffer pool definition is fixed when the CFW library is delivered to the customer. The customer is allowed then to define certain configuration values (number of buffer pools, size of the buffers, number of the buffers, etc. . . . ) in a Customer Specific Configuration File. This file should give enough parameters so that the customer specific startup sequence triggers the API calls to create the buffer pools. The API should control that the total RAM size the customer is trying to allocate for the buffer pools does not exceed the maximum size allocated statically in the CFW library. If still within the limits, the API would call the appropriate OS routines to do the real creation of pools. Some parameters for these calls can be provided by the customer and others can be derived by the API. Of course the Pool Ids returned by the OS would be relayed back to the customer's application for later use in other API calls.

When the customer application requests/returns a buffer from/to a pool, the API maps it into the appropriate OS calls. In case of buffer allocation, the OS allows for the task to wait and block until a buffer is available but this should not be supported since it can produce unpredictable effects in the customer code. This case can be treated as a SW exception due to badly configured or badly predicted customer configuration parameters.

Unless explicitly needed by a customer, the support for the sharing of ownership over buffers and therefore the AME API does not need to support the manual increase of the buffer reference count. Ownership of a buffer is transferred when the buffer is sent to another task by means of a message sending. Other calls to give back status values with the buffer sizes, number of buffers free, etc. should be supported by the API.

Hence, in accordance with embodiments of the present invention, buffer management preferably provides access to multiple pools of buffers (fixed size block of memory). Application modules can request the Buffer Manager to get a buffer from a pool. If no buffer is available the task can wait for the buffer (with a timeout to stop waiting or with indefinite waiting). If the buffer becomes available, it is given to the task waiting at the top of the buffer's pool wait queue.

Buffers can preferably be shared and owned by different tasks and are only returned to the pool when the last task releases it.

Speed of execution does not depend on number of pools or buffers and the number of pools or buffers is only limited by memory availability and is defined in the 3.2.9 System Configuration Module.

A pool of buffers comprises any number of buffers of a uniform size measured in bytes (multiple of 4 and greater than or equal to the target dependent minimum).

Buffers can be created dynamically or can be predefined to be created during startup.

The OS supports calls to create a buffer pool before the application can use it.

The parameters are the number of buffers in the pool, the size of each buffer, a pointer to RAM storage for all the buffers in the pool and an optional 4-character Tag. It then returns a buffer pool id that can be used by the application to identify the buffer pool.

The OS has calls to derive the buffer Pool Id from an allocated buffer pointer and or from a 4-character Tag. There is an associated call to delete the complete buffer pool, even though this functionality might not be needed.

After the pool has been created a task can request a buffer from the pool. This call returns a pointer to the first byte of the buffer. The task can wait if there are no buffers available. Alternatively, this is not used. Instead it can be considered as a SW exception due to bad dimensioning of buffer pools. The task can de-allocate the buffer with the appropriate call in which the pointer to the first byte of the buffer to be de-allocated is given. If the use reference count is zero the OS returns it to the pool. The OS manages this reference count and hides the real buffer de-allocation from the tasks.

This can be used for buffer sharing.

Numerous calls are provided to increase the reference count manually (for buffer sharing), to give back status values with the buffer sizes, number of buffers free, etc.

3.2.10 Memory Management

The issues raised for the Memory Management are quite similar to those of the Buffer Management. However, Buffer Management is used for the allocation of message buffers of predefined sizes, whereas the Memory Management is used for the dynamic allocation of arbitrary sized chunks of memory for purposes different than message passing. Part of the memory allocated statically for customer application purposes should be dedicated for the dynamic allocation of memory if so needed by the customer application. The total amount of memory available for customer memory pool definition is fixed when the CFW library is delivered to the customer. The API would control that the total RAM size the customer is trying to allocate when creating the memory pool does not exceed the maximum size allocated statically in the CFW library. If still within the limits, the API would call the appropriate OS routines to do the real creation of the memory pool. Since only one big memory pool with a big memory section is needed to be created, the Pool Ids returned by the OS can be kept within the API and would not be relayed back to the customer's application. When the customer application requests/returns a memory block it does not need to specify the Memory Pool Id to the API. The API would map it into the appropriate OS calls after filling in the stored Memory Pool Id.

The Stack allocated for every customer task could be taken from the Memory Pool from where the customer's task can allocate memory blocks or else be part of a special Memory Pool allocated in the customer dedicated RAM.

The Memory Manager permits any block of memory (including the ones acquired from the Memory Manager) to be treated as memory from which smaller private blocks can be dynamically allocated. This feature can be used by the API to partition memory into different Memory Pools but the API will not open this for customer use (a task can get a memory block dynamically but cannot request that block to be converted into a manageable Memory Pool).

Even though the OS can support the shared ownership of a memory block by different tasks by means of the manual increase of the reference count, the API does not need to support it but it can be provided. Data sharing between customer's tasks is not considered a good programming practice, especially since the message passing should be enough for the inter-task communication of the customer's Higher Layers.

When a customers task frees an allocated block of memory, the API can check the pointer consistency of the operation (with the potential help of the status returned by the associated OS call).

Even though a task can request the OS for the size of a memory block (in case the task is given ownership of a block by another task), the API need not provide that service. The only data sharing between customers task should be that of buffers passed via messages.

Since the corruption of the contents of a memory location outside the memory block can have unpredictable and potentially disastrous effects, the API should provide control and checking of all the used pointers, checking of proper index ranges, etc. . . .

Memory copies should preferably be done through the API.

The API need not support task requests to grow or shrink the size of a memory block to suit the task's needs.

The API need not support the deletion of an entire memory pool since it is not a common situation in embedded RTOS applications.

The Memory Manager allows the dynamic allocation of contiguous memory blocks. Requests to allocate and de-allocate the memory blocks are done to the Memory Manager. The Memory Manager permits any block of memory (including the ones acquired from the Memory Manager) to be treated as memory from which smaller private blocks can be dynamically allocated. This feature allows a task that has well defined memory requirements to reserve a block of memory for its own private use. The task can then call the Memory Manager to control the allocation and release of smaller blocks from within the larger block.

High level language memory management procedures (as malloc, calloc or free) cannot be called from concurrently executing tasks since the procedures are usually non-reentrant.

In accordance with embodiments of the present invention the Memory Manager allows the static and dynamic definition of a set of memory pools, each pool containing a set of one or more sections of contiguous memory. Then Memory Manager procedures are called to obtain a memory block of any size from a particular memory pool and to release it back to the pool when it is not longer required.

As for the buffer pools, memory block ownership can be increased manually so that tasks can share them. The number of memory pools and amount of memory in the memory blocks is only limited by memory availability.

A memory pool comprises any number of memory sections of varying sizes measured in bytes (size multiple of 4 and greater than or equal to a target dependent minimum). However, a memory pool usually comprises a single large memory section.

When defined statically, memory pools and sections can be predefined in the System Configuration Module.

When a memory pool is created the Memory Manager returns a memory pool id. The application needs to keep track of that id. A 4-character Tag can be assigned to that id and this id can be derived from the tag by means of a particular call. After an empty memory pool has been created, calls can be made to add memory sections to that particular memory pool (size in bytes of the section plus the pointer to the beginning of the section). There are no limits on the number of memory sections attached to a pool. The manager treats 2 sections as disjoint pieces of memory even though they might happen to be contiguous. The manager maintains a linked list of free memory blocks, which is internal to the manager.

A task can request a memory block of a particular size in a memory pool. If a block of that size is found the manager will return it with its actual size (eventually larger than asked). If no free blocks of at least that size are available, the manager returns and error and an indication of the largest size available. The OS provides a call to derive the Pool Id from a given allocated memory block. When the task has finished using the memory block it can release it back by means of another call. The caller specifies the block to release by giving the pointer allocated previously. The Memory Manager decrements the user count and if it is zero it returns the block to the free list.

If there are adjacent blocks free they are merged to form a larger free block by the Memory Manager. The user reference count can be incremented manually to provide memory sharing between tasks.

A task can request the OS for the size of a memory block (in case the task is given ownership of a block by another task). If a task corrupts the contents of any memory location outside the memory block, the effects are unpredictable and potentially disastrous.

The OS allows requests from a task to grow or shrink the size of a memory block to suit the task's needs. If it is to be shrunk a piece is carved from the high end of the block and a new fragment is added to the free list. If it is to be grown, the Manager checks if there is an adjacent block in the upward memory direction that is free and a larger block is produced.

The application can delete an entire memory pool. It is responsibility of the application to make sure that no blocks are still being used when this happens.

For private memory allocation, a task can use request the OS for the creation of the memory pool and pass a pointer to a private area of memory whose access is to be controlled by the Manager and the size of it. This private area can be a block obtained from another pool. The Manager converts it to a memory pool and returns an id that is private for the task (as long as the task does not make it public, that pool can be considered private to the task).

3.2.11 Synchronization Management

Considering that the customer application can be running tasks implementing activities with low real time constraints, it is considered unnecessary to use synchronization mechanisms at that level. Therefore, the API need not provide any means for synchronization between customer's tasks. Moreover, such mechanisms are too prone for misuse. The customer's task are preferably normal standard tasks based on clearly defined SDL transitions supported by the message passing mechanism provided already by the API.

The OS can provide different synchronization mechanisms. One of them is the provision of semaphores with priority queuing and timeout. There are two types of semaphores: resource semaphores and counting semaphores. A resource semaphore is a binary semaphore to limit access to each resource to a task at a time (the ownership and release of a resource is governed by calls to the Semaphore Manager). The counting semaphores can be used for mutual exclusion and resource management. The task can specify the priority of the request and an optional timeout. If a task, ISP or Timer Procedure signal the semaphore, the Semaphore Manager grants the access to the semaphore to the task waiting at the top of the semaphore queue.

The other type is the provision of events. A task can request the Event Manager to suspend its execution until one or more events occur. When a task, ISP or Timer Procedure detects an event, it signals the event to the Event Manager, which checks which task is waiting to that combination of events and resumes its execution.

3.2.12 Timer Management

The API should provide the means for the customer's tasks to start and stop timers. As Timer Procedures are executed in the context of the Kernel Task and special care must be taken in the type of actions defined in the Timer Procedures, the API should not leave open to the customer the possibility to define such Timer Procedures.

Instead, the Timer Procedure will be used by the API to send the corresponding expiry message to the customer task.

The timer management as defined in the RTOS ABSTRACTION LAYER provides all expected functionality for the customer and therefore the API can be based on calls to the RTOS ABSTRACTION LAYER instead of direct calls to the OS.

Timing in the OS can be implemented using interval timers (e.g. 32-bit counters). The timing resolution is based in multiples of the system tick (the system tick is based in the HW Timer). The OS preferably provides the means to create timers. The associated parameters are the timer period (one shot or periodic), a pointer to a Timer Procedure (to be executed when the timer expires) and an optional 32-bit application dependent parameter. A Timer Id is returned which needs to be managed by the application. A 4-character Timer Tag can be assigned to a Timer Id. The timer is started by means of a separate call giving the timer interval and stopped by giving a zero interval. A task can read the time remaining via the corresponding call.

A Clock Handler triggers the Kernel Task if required (at the user defined system tick interval if and only if there is an outstanding timing activity required in the system). If a timer has expired, the Kernel Task executes the associated application dependent Timer Procedure (as the Kernel Task has priority 0, the Timer Procedures are executed at the highest task priority in the system). A Timer Procedure must not use any directives that would in any way force the Kernel Task to wait for any reason.

A subset of services to send messages, signal events or wake tasks can be used in the Timer Procedure. The OS provides calls to convert milliseconds in system ticks and others alike. The maximum number of application interval timers is defined in the System Configuration Module.

3.2.13 Interrupt Handling

An IRQ Interrupt Model can be used with the RTOS, which means that the IRQ interrupts are handled by conformant ISPs through the OS Interrupt Supervisor and a subset of OS services can be used within the handlers.

FIQ interrupts need not be handled via the OS. Instead, FIQ interrupts can be configured as pseudo NMI, which means that OS does not install the ISP into the FIQ hard vector, that the application calls to enable/disable interrupts do not affect the FIQ interrupt and that the handler cannot use any of the OS services. The application can still change the FIQ interrupt state directly into the Current Program Status Register (CPSR) by calling an OS routine. The application can use another to install a FIQ handler into the hard vector.

The API should provide the customer with the possibility to define an interrupt handling routine for a specific IRQ interrupt. The offered API routine should call the necessary OS procedures to install the entry into the hard vector. The API should not provide access to the customer for FIQ interrupts since most of them are dedicated to really stringent Real Time activities dealing with the BT Air Interface.

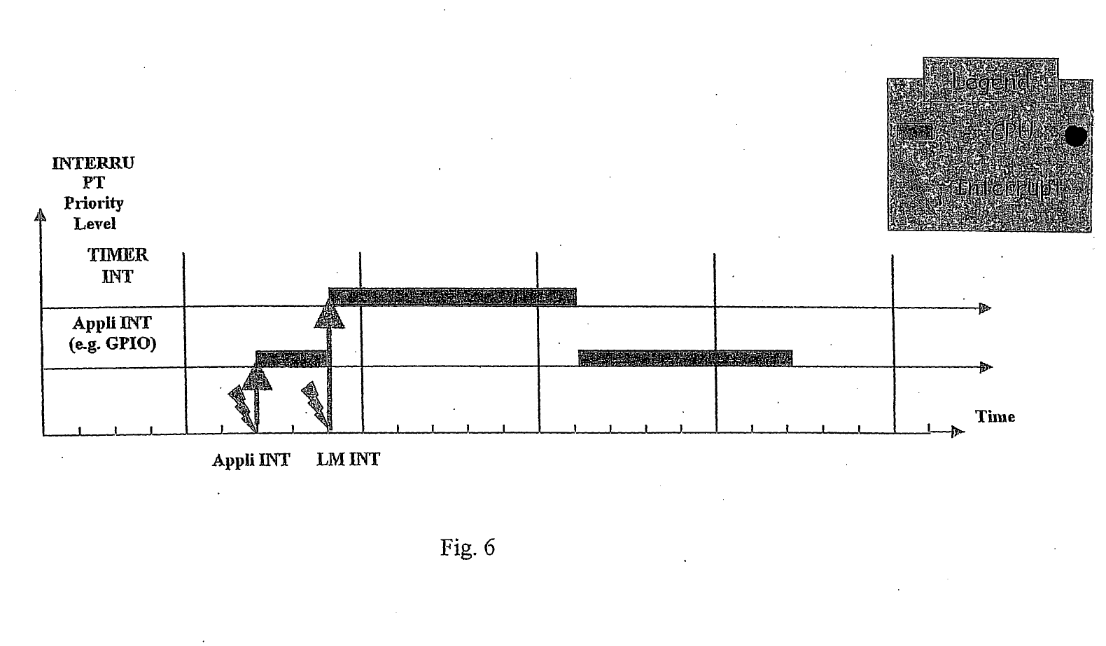

Interrupts provide the key to fast response to external events occurring asynchronously in time. From time to time, the OS must inhibit interrupts while it performs a critical, indivisible sequence of operations. The OS keeps such intervals very short. For instance, even while the OS is switching from one task to another, it is able to respond to interrupts. In this case, it is possible that, as a result of servicing the interrupt, the OS may actually be instructed to switch to a task of higher priority than the one which it otherwise would have picked. Higher priority interrupts are nested within the application interrupt handling see FIG. 6. Only lower layer s determine the interrupt latency not the applications. This keeps any BT link alive and provides a guaranteed latency for the most critical events.

When an interrupt occurs, most processors automatically vector to a user provided Interrupt Service Procedure. If the device procedure wishes to use any of the available services, it must notify the Interrupt Supervisor that the interrupt has occurred. It is then free to use a subset of the services that are applicable to interrupt servicing. These include triggering tasks for execution, sending messages to tasks, waking tasks and signaling events.

Once the device has been serviced and the source of the interrupt cleared, the OS is notified with a call to the Interrupt Supervisor. If, as a consequence of servicing the interrupt, a task of higher priority than the interrupted task is capable of execution, the OS will automatically initiate a task switch. If no higher priority task is ready to begin or resume execution, the OS returns to the interrupted task.

To improve interrupt response, the OS permits nesting of interrupts on processors that support this feature. An extra HW register can be provided to handle this.

When an interrupt occurs the processor saves enough processor dependent information to permit the processor to resume the interrupted process. The ISP needs to save the registers is wishes to use, services the device, restores the registers, enables the interrupt and returns to the execution program at the time of the interrupt.

There are two types of ISPs:

Non Conforming ISP: must quickly service the device to remove the interrupting condition, must preserve all the registers it uses, must not call any service procedures and executes in the context and stack of the process (task, ISP, kernel) which was interrupted. It should not allow to be interrupted by a conforming ISP.

Conforming ISP: comprises an ISP root and an Interrupt Handler. The processor vectors to the ISP root, which informs the Interrupt Supervisor that the interrupt has occurred. The Interrupt Supervisor preserves the state of the interrupted task and might switch to an interrupt stack. Then the Supervisor calls the associated Interrupt Handler. This handler can use a subset of the service facilities. The interrupts with less or equal priority are disabled.

The ARM core has two interrupt lines: IRQ and FIQ. IRQ interrupt handling has priority over any task in the system (including the Kernel Task that runs with the highest task priority). FIQ interrupt handling has higher priority than IRQ and therefore a FIQ interrupt will preempt the servicing of an IRQ interrupt.

3.2.14 Exception Management

The lowest level of exception handling is the one provided by the Fatal Exit procedure done when certain conditions are encountered which make the continuation of the execution unpredictable. In that case the OS forces a branch to a fatal error handler. The default implementation of this handler disables interrupts and loops forever until a HW reset is performed. Depending on the development/debugging platform, within the fatal error handler, means to log information via the UART for example can be provided. If applications (either customer code or API) encounter conditions which are deemed fatal (Application Faults), they could call the fatal error handler with user defined exit codes.

Another level of exception handling would be the provision of traps. Even though the OS could support the definition of Task Error Traps (for errors like division by zero, overflow, etc. . . . ), the processor does not need to support such exceptions and therefore Task Error Traps need not be defined.

The next level is the provision of User Error Procedures. Most OS procedures return an error status to the caller, but before doing so, the OS calls an User Error Procedure and passes the error code and the Task Id which was executing. The default User Error Procedure can ignore warnings, but in case of errors a public break procedure can be called, e.g. by putting a breakpoint in there so that all error conditions detected by the OS can be caught during testing. In this context the API can define its own (customer) negative error conditions or warning conditions to identify error conditions when calling the error procedure. In order to detect problems during development, the API should provide extensive use of assertions and the possibility to trace/log debugging information over the UART. The API will provide the means to switch on/off the tracing/debugging and the way different exceptions are handled depending on whether the target environment is deemed for development or for production (this switch could be done by a jumper setting for example).

The OS preferably provides the means to handle HW and SW exceptions. As indicated above, one is the use of a Fatal Exit procedure done when certain conditions are encountered which make the continuation of the execution unpredictable. In that case the OS forces a branch to a fatal error handler. The default implementation of this handler disables interrupts and loops forever until a HW reset is performed. The following are examples of such conditions:

Insufficient memory: normally at startup when the Managers are initializing a portion of their private Data Segment. If they need more data than the one provided in the System Configuration, the OS takes a fatal exit.

Task Error Traps: each task can be assigned a Trap Error Handler routine which is called by the OS when there are errors like division by zero, overflow, etc. This trap can be assigned by a proper OS call. If the trap is not assigned or the pointer to the handler is null, the OS uses the fatal error handler.

Application Faults: if applications encounter conditions which are deemed fatal, the fatal error handler is called with user defined exit codes.

Another possibility is the provision of User Error Procedures. Most OS procedures return an error status to the caller. Before doing so, the OS calls an User Error Procedure and passes the error code and the Task Id which was executing. The default User Error Procedure ignores warnings, but in case of errors a public break procedure is called.

3.2.15 The OS Managers

Some of the services of the OS are part of the core functionality and others are part of Managers that can be compiled in and out when configuring the system for a particular usage. The following is a list of possible managers:

Time/Date Manager [optional]

Semaphore Manager [optional]

Event Manager [optional]

Mailbox Manager [optional if use of Message Exchange Manager]

Message Exchange Manager [optional if use of Mailbox Manager]

Buffer Manager Memory Manager Circular List Manager [optional]

Linked List Manager [optional]

4. RTOS Abstraction Layer

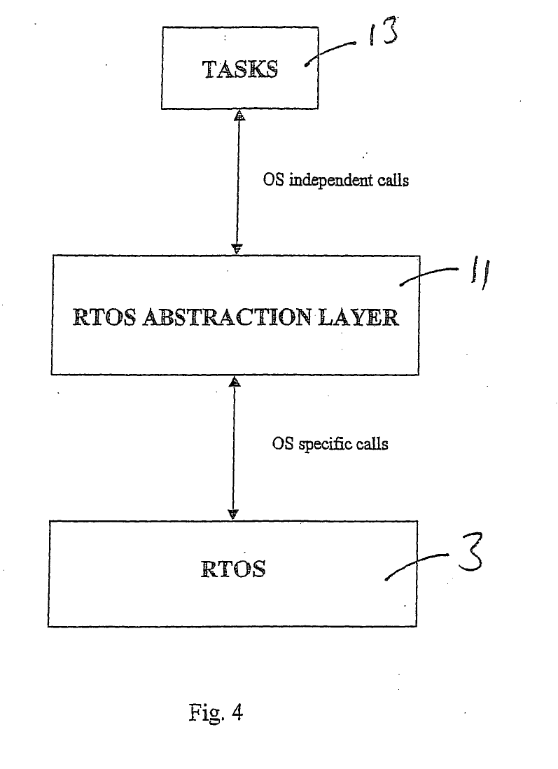

Embodiments of the present invention may make use of a RTOS ABSTRACTION LAYER which is a thin layer that allows the BT Lower Layer software to be designed and implemented without knowing the specifics of the target RTOS kernel, i.e. an RTOS abstraction layer 11. For example, SW does not need to call the RTOS directly but uses the RTOS ABSTRACTION LAYER instead. FIG. 4 shows the relationship between the RTOS ABSTRACTION LAYER function calls and the target real-time operating system function calls. The BT Lower Layers that use the RTOS ABSTRACTION LAYER need not call the target real-time operating system calls directly.

The RTOS ABSTRACTION LAYER exports several functions to implement the following:

task communication

memory management

software timers

signal queuing

A RTOS ABSTRACTION LAYER task is a C function call that never exits.

Associated with the task is an input queue on which all signals sent to it are stored. In addition each task has a reserved area of memory called the stack. The stack holds local variables and function return addresses. In general a task is designed to receive, process and then free the signals back to the system or send them on to other tasks.

A task can be in one of three states:

running

ready

waiting.

Only one task can be running at any single point in time. The task with the highest priority that is ready to run will become the running task. If a task of higher priority becomes ready, the running task will be suspended and the new task of higher priority will start running. A task waiting for a signal to arrive on its input queue or waiting for memory to become available is held in the waiting state.

If an interrupt occurs, the running task is suspended and placed on the ready queue. The interrupt runs to completion after which the ready task with the highest priority will run. Note that the interrupt routine may have allowed another task of higher priority to become ready (by sending it a signal for example).

Each task has one associated input queue on which all signals sent to the task are placed. Tasks cannot have more than one input queue. Signals are taken from the queue by “first in first out” (FIFO) order. Signals received by a task that needs to be stored for later processing can be held on internal queues.

Tasks can start and stop one shot timers. The RTOS ABSTRACTION LAYER notifies a task that a timer has expired by sending it a timer expiry signal.

4.1 Tasks and Queues

The RTOS ABSTRACTION LAYER permits a number of concurrent tasks to exist and communicate with each other. Tasks are declared to the system at configuration time and are created by the real-time kernel during kernel initialization.

All tasks are static, which means they are created once and exist permanently. It is not possible to dynamically create and destroy tasks through the RTOS ABSTRACTION LAYER.

The RTOS ABSTRACTION LAYER creates the tasks by calling the dynamic task creation calls of the OS during startup. Therefore, in accordance with an embodiment of the present invention the API “extends” the RTOS ABSTRACTION LAYER to support that (i.e. better to add the functionality at RTOS ABSTRACTION LAYER than doing it at API level).

4.2 Task Communication.

Tasks communicate with each other using signals. A signal is composed of a unique reference id and a signal body (a C structure) held in dynamic memory. A task has to create the signal (reserve the dynamic memory), fill the contents and then send the signal to a defined task. The signal is stored on the destination tasks input queue until it is received. Once the signal has been sent, the sender no longer owns the memory associated with the signal. As soon as the destination task receives the signal, it becomes the owner of the associated memory. It is the responsibility of the receiving task to free the memory back to the system or send the signal to another task.

4.3 Memory Management

The RTOS ABSTRACTION LAYER provides tasks with the facility to allocate, reallocate and free blocks of dynamic memory. If memory is available, the RTOS ABSTRACTION LAYER returns the start address of a block of memory that is at least as large as the size requested. The configuration of dynamic memory is specific to the target kernel and target application. In general, however, dynamic memory is organized into one or more Memory Pools each containing a number of equally sized memory blocks.

The number and size of memory blocks within each memory pool is defined at configuration time. The RTOS ABSTRACTION LAYER uses the static configuration and creation of memory pools offered by the OS. However, the OS offers as well the possibility to create the pools dynamically, and this possibility can be exploited by the API.

A library is compiled already and the amount of RAM left is known for the person producing the application. Dynamically creation of the pools (as part of the customer specific startup sequence for example), is preferred. In this case the API can request the OS to do the creation in a controlled manner so that the available RAM is not exceeded. The present invention provides an extension to the RTOS ABSTRACTION LAYER functionality to provide this.

4.4 Timer Management

The RTOS ABSTRACTION LAYER provides a general-purpose mechanism for starting and stopping software timers. A task can have multiple timers running concurrently.

A task requiring use of a timer simply has to specify:

the duration of the required timer

the task to send the timeout to. This is optional if the task that starts the timer is always the recipient task. Since the OS provides a call to know the task's id of the current task, the API can fill this in without the need for the customer to supply it.

This simplifies the prototype of this function.

a value (called user value) which identifies the timer to the recipient task.

This information is passed to the RTOS ABSTRACTION LAYER, which returns a timer identity to the task. This timer identity is a number that uniquely identifies the software timer to the kernel, and to the task (in conjunction with the user value).

The timer expiry signal contains the Timer Id and user value of the timer.

When a task receives a timer expiry signal it must check the timer id specified in the timer expiry signal against a list of the task's active timers to ensure that the timer expiry signal is valid. This avoids the problem where a timer has been stopped, but the timer expiry signal is already in the recipient task's input queue.

If repetitive time-outs are required, this can be achieved by restarting the timer after each timeout. The task has responsibility for maintaining a count of the number of time-outs.

4.5 Internal Task's Queues (Unit Queues)

The RTOS ABSTRACTION LAYER provides a facility to queue signal buffer structures for later processing. This permits a form of selective receiving (or signal prioritizing) of signals to be implemented. A task requiring this facility must declare a unit queue structure in its own data space, and then use the RTOS ABSTRACTION LAYER function calls to manipulate the queue. This functionality can be provided in the API in case the customer's task needs to defer signals.

4.6 Instantiation

The RTOS ABSTRACTION LAYER provides macros in order to create several tasks that use the same task function and these macros are expanded at compilation time. Each of these instances needs their own stack, queue and task id.

One important user requirement is that the code must be reentrant.

5. Compilation/Linking

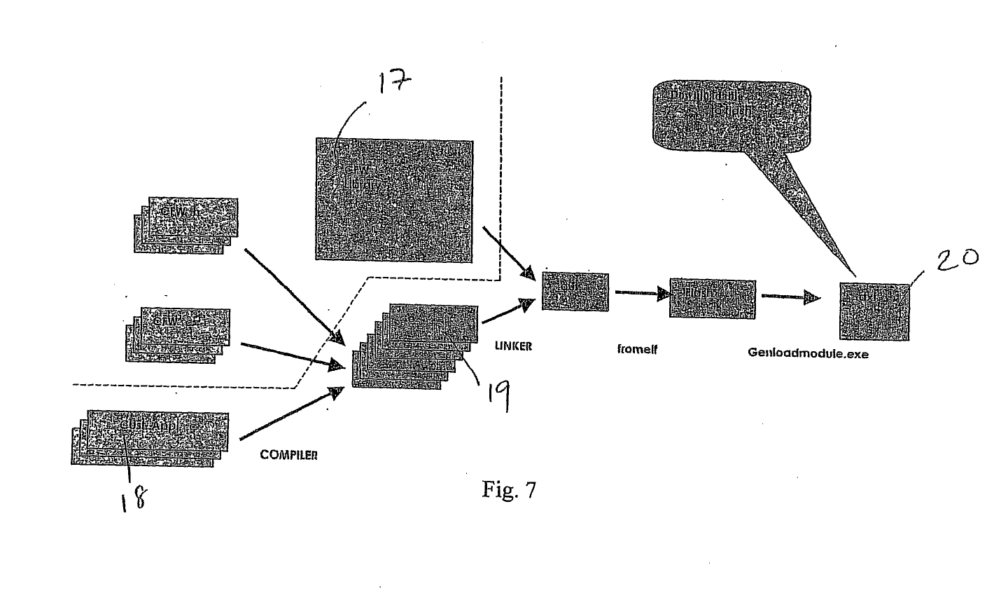

During the build process the user application source code 18 is compiled and linked together with a CFW library file 17 using a linker 19, in order to form together an .axf file 20 which is downloadable to the target platform of the telecommunications device. FIG. 7 gives an overview of the steps performed in the build procedure.

The CFW library 17 is a library of software program products comprising a set of routines for an embedded software application requiring SW protocol layers, profiles and/or application code embedded on a processor, the library providing an interface between the software application running on the processor and the SW protocol layers and/or the profiles and/or the application code. The CFW library 17 comprises software for the RTOS 3, the RTOS abstraction layer 11, the RTOS library, 5 the lower layer stack 9 and the API 12 as detailed above. The lower layer stack 9 can be Bluetooth lower layer SW protocol. The CFW 17 library can be stored on a computer readable medium, such as a CD-ROM or DVD-ROM or a memory or data storage device, e.g. for delivery to the customer.

For example, the BT stack (that includes the framework CFW defined to support the customer development) is delivered to the customer in the form of the CFW library or object file. The customer needs to compile and link their developed sources together with the CFW library in order to obtain an image that can be run on the microprocessor of the telecommunications device. The customer uses the BT board prototypes. The complete program compiled by the customer, when executed on the microprocessor of the telecommunications device, runs the RTOS, the RTOS abstraction layer, the API, the telecommunications protocol stack, etc. as described above and hence provides all the functionality of all these items and the customer specific application program.

It is to be understood that although preferred embodiments, specific constructions and configurations, as well as materials, have been discussed herein for devices according to the present invention, various changes or modifications in form and detail may be made without departing from the scope and spirit of this invention.

What is claimed is:

1. A library of software program products, the library comprising a set of routines for an embedded software application requiring SW protocol layers, profiles and/or application code embedded on a processor, the library providing an interface between the software application running on the processor and the SW protocol layers and/or the profiles and/or the application code.

2. The library according to claim 1 wherein the interface is between the software application running on the processor and a telecommunications module.

3. The library according to claim 2 wherein the telecommunications module is the Bluetooth lower layer SW protocol.

4. The library according to claim 2, wherein the interface uses telecommunications controller interface communications.

5. The library according to claim 4 wherein the communications are HCI communications for communication with the telecommunications module.

6. The library according to claim 2, wherein the software application communicates with a telecommunications module for executing a telecommunications protocol.

7. The library according to claim 6 wherein the software application communicates with a hardware input/output interface.

8. The library according to claim 7 stored on a computer readable medium.

9. The library according to claim 8, wherein the medium is a CD-ROM or DVD-ROM or a memory or data storage device.

10. A telecommunications device with an interface towards an underlying operating system, to layers of a telecommunications protocol and optionally towards any hardware available for an embedded application.

11. The telecommunications device according to claim 10 wherein the interface communicates with the telecommunications protocol via telecommunications controller interface communications.

12. The telecommunications device according to claim 10, wherein the interface is an API.

13. Host processing system for executing the library of computer programs in accordance with claim 1.

14. An API for providing functions to a software application requiring SW protocol layers, profiles and/or application code embedded on a processor, the API communicating towards an underlying operating system, to layers of a telecommunications protocol and optionally towards any hardware available for an embedded application.

15. An API according to claim 14, wherein the API communicates with the protocol layers using HCI communications.

16. The API of claim 14, stored on a computer readable medium.

17. A method of embedding a software application requiring SW protocol layers, profiles and/or application code embedded on a processor, the method comprising: generating API for communicating towards an underlying operating system, to layers of a telecommunications protocol and optionally towards any hardware available for an embedded application.

18. Method of operating a telecommunications device with an interface towards an underlying operating system, to layers of a telecommunications protocol and optionally towards any hardware available for an embedded application.

19. The method according to claim 18, wherein the interface is an API.
